(19) United States
(12) Patent Application Publication
(10) Pub. No.: US 2015/0339223 A1
(43) Pub. Date: Nov. 26, 2015

(54) MEMORY SYSTEM AND METHOD

(71) Applicant: Kabushiki Kaisha Toshiba, Minato-ku (JP)

(72) Inventors: Hiroki MATSUDAIRA, Funabashi (JP); Ryuji NISHIKUBO, Kawasaki (JP); Norio AOYAMA, Machida (JP)

(73) Assignee: Kabushiki Kaisha Toshiba, Minato-ku (JP)

(21) Appl. No.: 14/479,754

(22) Filed: Sep. 8, 2014

Related U.S. Application Data
(60) Provisional application No. 62/001,690, filed on May 22, 2014.

(51) Int. Cl. G06F 12/02

(52) U.S. Cl. CPC G06F 12/0246; G06F 2212/7201

(57) ABSTRACT

According to one embodiment, a memory system includes a nonvolatile semiconductor memory and a controller. The nonvolatile semiconductor memory includes a plurality of parallel operation elements each having a plurality of physical blocks. The controller drives the plurality of parallel operation elements in parallel. The controller associates each of a plurality of logical blocks with a plurality of physical blocks each belonging to different parallel operation elements. The controller levels, among the plurality of logical blocks, the numbers of Bad blocks included in the plurality of physical blocks being associated with each of the plurality of logical blocks.

### CROSS-REFERENCE TO RELATED APPLICATIONS

This application is based upon and claims the benefit of priority from U.S. Provisional Application No. 62/001,690, filed on May 22, 2014; the entire contents of which are incorporated herein by reference.

### FIELD

Embodiments described herein relate generally to a memory system and a method.

### BACKGROUND

A memory system such as an SSD (Solid State Drive) includes a storage area configured of a plurality of physical blocks. A technology for accessing the plurality of physical blocks in parallel is known as a technology for increasing access speed.

### BRIEF DESCRIPTION OF THE DRAWINGS

FIG. 1 is a diagram illustrating a configuration example of a memory system of a first embodiment;

FIG. 2 is a diagram illustrating a configuration example of each memory chip;

FIG. 3 is a diagram illustrating a configuration example of each physical block;

FIG. 4 is a diagram illustrating a configuration example of each logical block;

FIG. 5 is a diagram illustrating various pieces of data stored in the memory system;

FIG. 6 is a diagram illustrating a data structure example of first translation information;

FIG. 7 is a diagram illustrating a data structure example of second translation information;

FIG. 8 is a flowchart illustrating the operations of the first embodiment to generate the second translation information;

FIG. 9 is a diagram illustrating an array of physical block numbers after execution of the process of S2;

FIG. 10 is a diagram illustrating an array after the process of S5;

FIG. 11 is a diagram illustrating an array of the physical block numbers of when a processing unit has set all rows as use targets regardless of the number of Bad Blocks;

FIG. 12 is a flowchart illustrating the operations of a second embodiment to generate second translation information; and

FIG. 13 is a diagram illustrating an array of physical block numbers after the process of S15.

### DETAILED DESCRIPTION

In general, according to one embodiment, a memory system includes a nonvolatile semiconductor memory and a controller. The nonvolatile semiconductor memory includes a plurality of parallel operation elements each having a plurality of physical blocks. Each of the plurality of physical blocks is a unit of data erasing. The controller drives the plurality of parallel operation elements in parallel. The controller associates each of a plurality of logical blocks with a plurality of physical blocks each belonging to different parallel operation elements. The controller levels, among the plurality of logical blocks, the numbers of Bad blocks included in the plurality of physical blocks being associated with each of the plurality of logical blocks.

Exemplary embodiments of the memory system and a method will be explained below in detail with reference to the accompanying drawings. The present invention is not limited to the following embodiments.

### First Embodiment

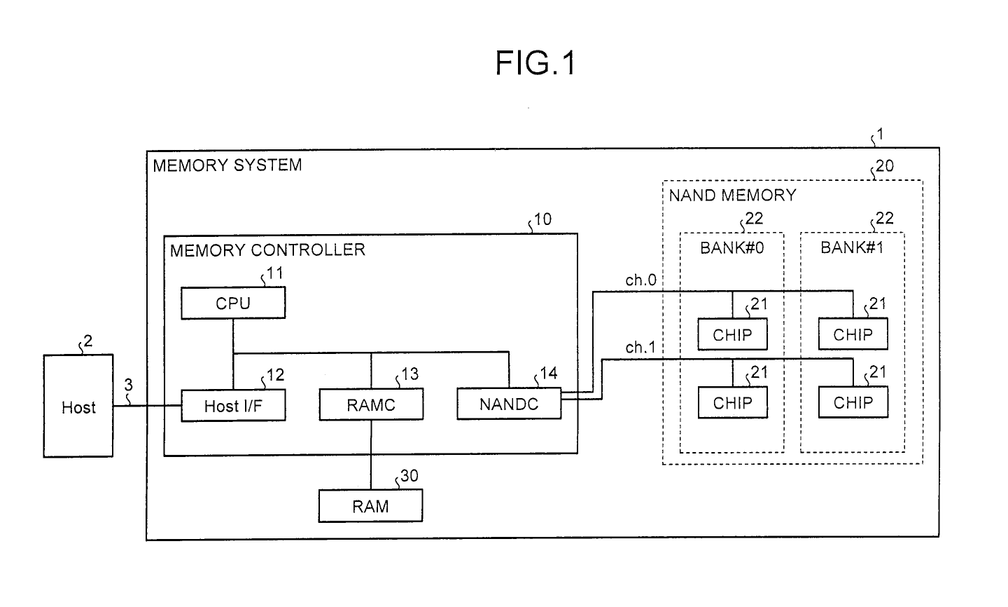

FIG. 1 is a diagram illustrating a configuration example of a memory system of a first embodiment. A memory system 1 is connected to a host 2 via a communication channel 3. The host 2 is a computer. The computer includes, for example, a personal computer, a portable computer, or a mobile communication device. The memory system 1 functions as an external storage device of the host 2. An arbitrary standard can be adopted as an interface standard of the communication channel 3. The host 2 can issue the write command and the read command to the memory system 1. The write command and the read command are configured to include logical address information that specifies an access destination (hereinafter referred to as the first logical address).

The memory system 1 includes a memory controller 10, a NAND flash memory (NAND memory) 20 used as a storage, and a RAM (Random Access Memory) 30. The kind of memory used as a storage is not limited only to a NAND flash memory. For example, a NOR flash memory, ReRAM (Resistance Random Access Memory), or MRAM (Magnetoresistive Random Access Memory) can be adopted as a storage.

The NAND memory 20 includes one or more memory chips (CHIPs) 21. Here, The NAND memory 20 includes four memory chips 21.

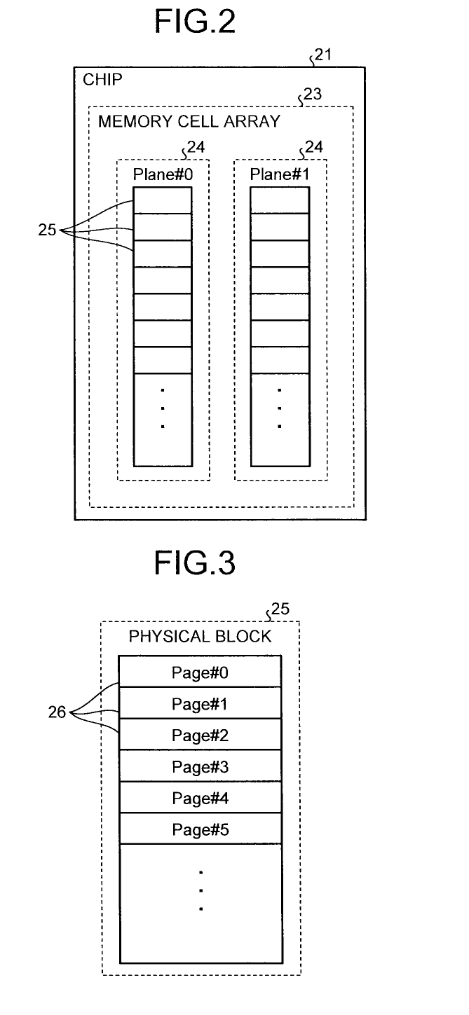

FIG. 2 is a diagram illustrating a configuration example of each memory chip 21. Each memory chip 21 includes a memory cell array 23. The memory cell array 23 is configured such that a plurality of memory cells is arranged in matrix form. The memory cell array 23 is divided into two areas (Districts) 24. Each District 24 includes a plurality of physical blocks 25. Each District 24 includes peripheral circuits (for example, a row decoder, a column decoder, a page buffer, and a data cache) independently of each other. Accordingly, the plurality of Districts 24 can independently execute erasure/write/read in parallel. The two Districts 24 in each memory chip 21 are specified using plane numbers (Plane#0 and Plane#1).

The physical block 25 is the unit of erasure in each District 24. FIG. 3 is a diagram illustrating a configuration example of each physical block 25. Each physical block 25 is configured to include a plurality of physical pages. A physical page 26 is the unit of write or read in each District 24. Each physical page 26 is identified by the page number.

Each of the four memory chips 21 configuring the NAND memory 20 is connected to the memory controller 10 via one of two channels (ch.0 and ch.1). Two memory chips 21 are connected to each channel. Each memory chip 21 is connected to only one of the two channels. Each channel is configured of a group of lines including an I/O signal line and a control signal line. The I/O signal line is a signal line to transmit and receive data, an address, and a command. A bit width of the I/O signal line is not limited to one bit. The control signal line is a signal line to transmit and receive a WE (write enable) signal, a RE (read enable) signal, a CLE (command latch enable) signal, an ALE (address latch enable) signal, a WP (write protect) signal, and the like. The memory controller 10 can control the channels individually. The memory controller 10 controls the two channels in parallel and individually and accordingly can operate one of the two memory chips 21 connected to ch.0 and one of the two memory chips 21 connected to ch.1 in parallel.

Moreover, the four memory chips 21 configure a plurality of banks 22 capable of bank interleaving. Bank interleaving is one of methods of parallel operation. Specifically, bank interleaving is a method in which while one or more memory chips 21 belonging to one bank 22 is accessing data, the memory controller 10 issues an access request to another bank to reduce a total processing time between the NAND memory 20 and the memory controller 10. In the example of FIG. 1, two banks 22 are discriminated as BANK#0 and BANK#1. In more detail, one of two memory chips 21 connected to each channel configures BANK#0, and the other of the two memory chips 21 configures BANK#1.

In this manner, the memory controller 10 operates the two channels in parallel and performs bank interleaving on the two banks and accordingly can operate the four memory chips 21 in total in parallel. Moreover, the memory controller 10 accesses two Districts 24 simultaneously in each memory chip 21. The memory controller 10 collectively manages the plurality of physical blocks 25 that allows parallel access, as one logical block. For example, the plurality of physical blocks 25 configuring the logical block is erased as a single unit.

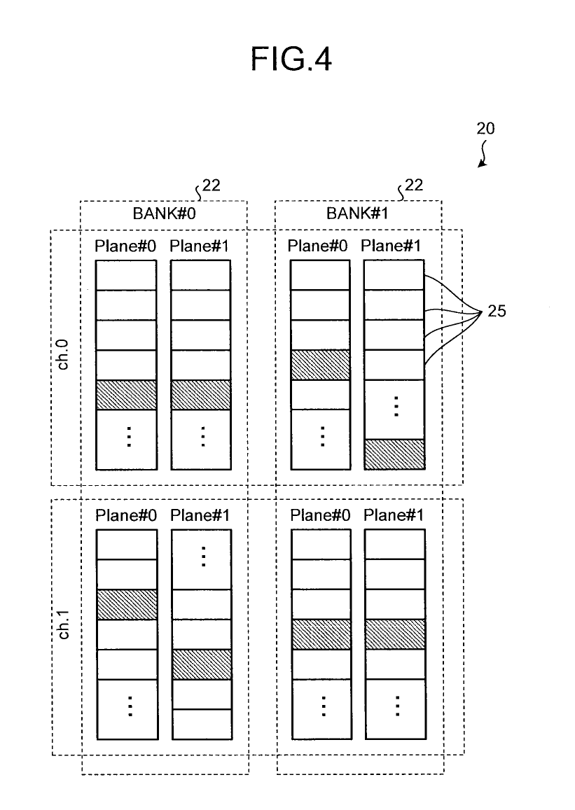

FIG. 4 is a diagram illustrating a configuration example of each logical block. The plurality of hatched physical blocks 25 illustrated in FIG. 4 configures one logical block. Specifically, a plurality of physical blocks 25 each of which belongs to a District 24 different, a bank different, or a channel different is organized into one logical block. In other words, in the example of FIG. 4, one logical block is configured of eight physical blocks 25. Physical locations of the physical blocks 25 configuring one logical block can be different in each District 24 as illustrated in FIG. 4. Each logical block is identified from one another by the logical block number.

Management information to allow the memory controller 10 to access the NAND memory 20 is stored in the RAM 30. The details of the management information are described later. Moreover, the RAM 30 is used by the memory controller 10 as a buffer to transfer data between the host 2 and the NAND memory 20. Moreover, the RAM 30 is also used as a buffer into which a firmware program (a firmware program 27 to be described later) is loaded.

The memory controller 10 includes a CPU (Central Processing unit) 11, a host interface (Host I/F) 12, a RAM controller (RAMC) 13, and a NAND controller (NANDC) 14. The CPU 11, the Host I/F 12, the RAMC 13, and the NANDC 14 are connected to one another by a bus.

The Host I/F 12 controls the communication channel 3. Moreover, the Host I/F 12 accepts a command from the host 2. Moreover, the Host I/F 12 transfers data between the host 2 and the RAM 30. The RAMC 13 controls the RAM 30. The NANDC 14 transfers data between the RAM 30 and the NAND memory 20. The CPU 11 functions as a processing unit that controls the entire memory controller 10 based on the firmware program 27.

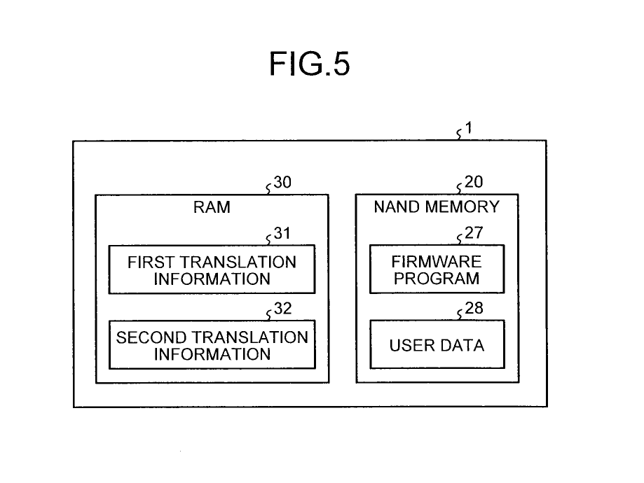

FIG. 5 is a diagram illustrating various pieces of data stored in the memory system 1. The firmware program 27 is stored beforehand in the NAND memory 20. The manufacturer sets the firmware program 27 in the NAND memory 20. The CPU 11 loads the firmware program 27 from the NAND memory 20 into the RAM 30 at startup. The CPU 11 then executes the firmware program 27 loaded into the RAM 30. Moreover, user data 28 being data to be written by the write command from the Host 2 is stored in the NAND memory 20.

First translation information 31 and second translation information 32 are stored as the management information in the RAM 30. The first translation information 31 and the second translation information 32 are information to be referenced by the processing unit to translate the first logical address specified by the Host 2 into a physical address of the NAND memory 20. The first translation information 31 and the second translation information 32 are saved in the NAND memory 20 at power shutdown, and loaded into the RAM 30 from the NAND memory 20 at startup.

The processing unit once translates the first logical address specified by the Host 2 into a second logical address being address information logically indicating the storage location of data on a cluster basis. The first logical address is translated into the second logical address using a predetermined translation algorithm such as shifting the first logical address rightward by the amount corresponding to the size of a cluster. The processing unit translates the second logical address into a third logical address including a logical block number based on the first translation information 31. In other words, the first translation information 31 is information in which a corresponding relationship between the second and third logical addresses is recorded. The processing unit converts the logical block number into a physical block number based on the second translation information 32.

The processing unit updates the first translation information 31 in response to a write to the NAND memory 20. Moreover, if data is moved between logical blocks for compaction, wear leveling, and the like, the processing unit performs an update in response to the movement.

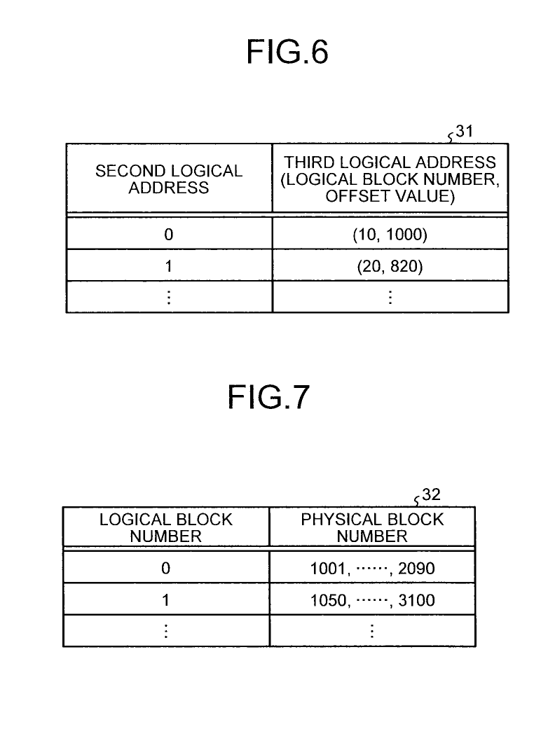

FIG. 6 is a diagram illustrating a data structure example of the first translation information 31. The first translation information 31 has a data structure in the form of a table in which the third logical address is recorded for each second logical address. The third logical address is configured of a combination of the logical block number and the offset value from the start of the logical block.

The second translation information 32 is information in which a corresponding relationship between the logical block and the physical block is recorded. At least Good Blocks among the physical blocks are recorded in the second translation information 32. The Good Block is a physical block that is not a Bad Block. FIG. 7 is a diagram illustrating a data structure example of the second translation information 32. The second translation information 32 has a data structure in the form of a table in which a plurality of physical block numbers is recorded for each logical block number. One logical block is configured of eight physical blocks. Accordingly, eight physical block numbers are recorded in each entry of the second translation information 32 (not illustrated).

The logical block number included in the third logical address is converted into eight physical block numbers based on the second translation information 32. The processing unit computes the location of a physical block out of eight physical blocks indicated by the eight physical block numbers, the location being indicated by the third logical address, based on the offset value included in the third logical address. The algorithm of computation based on the offset value is set beforehand in the firmware program 27.

The processing unit generates the second translation information 32 before shipment. The processing unit generates the second translation information 32 in accordance with Bad Blocks. The Bad Block indicates a physical block that is not used due to causes such as failure. The Bad Block is specified beforehand on a preshipment inspection. It is assumed that the processing unit can recognize the physical block number of a Bad Block when generating the second translation information 32. The second translation information 32 may be dynamically changed during the operation of the memory system 1 after being generated, or may not be changed once generated. If the processing unit is configured as in the case where the second translation information 32 is updated, the processing unit updates the second translation information 32 without changing the first translation information 31 at the update timing of the second translation information 32.

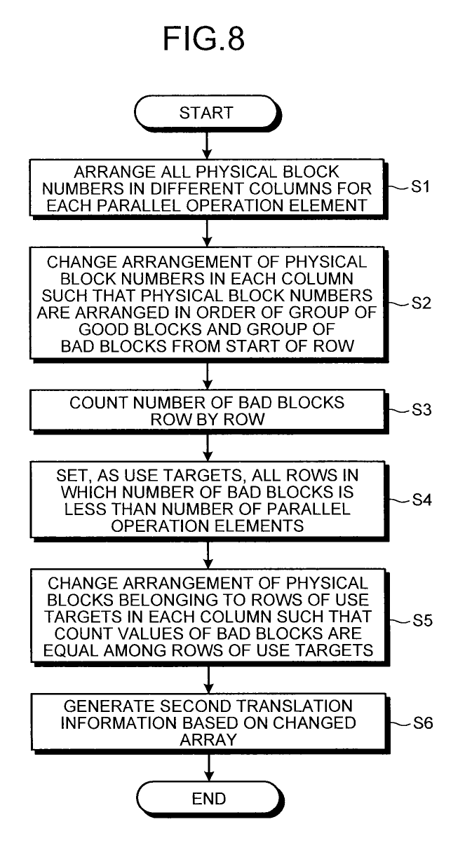

FIG. 8 is a flowchart illustrating the operations of the first embodiment to generate the second translation information 32. The processing unit executes, in the processes of S1 to S2, a first allocation process of allocating a plurality of physical blocks respectively to any of a plurality of logical blocks such that the total number of logical blocks including Bad Blocks is minimal in the NAND memory 20 and that the distribution of the numbers of Bad Blocks in the logical blocks is most biased. The processing unit subsequently executes, in the processes of S3 to S5, a second allocation process of classifying the logical blocks under a first logical block where the number of Bad Blocks is the number of parallel operation elements, and a second logical block where the number of Bad Blocks is less than the number of parallel operation elements, and changing the allocation of Bad Blocks to each second logical block such that the numbers of Bad Blocks in the second logical blocks are equal. The parallel operation element indicates a group of physical blocks specified by a combination of one channel, one bank, and one plane. The processes are described below.

Firstly, the processing unit generates an array of physical block numbers (S1). The array is generated by, for example, the RAM 30. The array generated here is assumed to be a two-dimensional array. Each of column components of the array corresponds to any of the parallel operation elements. Each of row components of the array the array corresponds to any of the logical block numbers. The arrangement of the physical block numbers in each column in the row direction is arbitrary at the time of the process of S1.

Next, the processing unit changes the arrangement of the physical block numbers in each column such that the physical block numbers are arranged in the order of the group of Good Blocks and the group of Bad Blocks from the start of the row (S2).

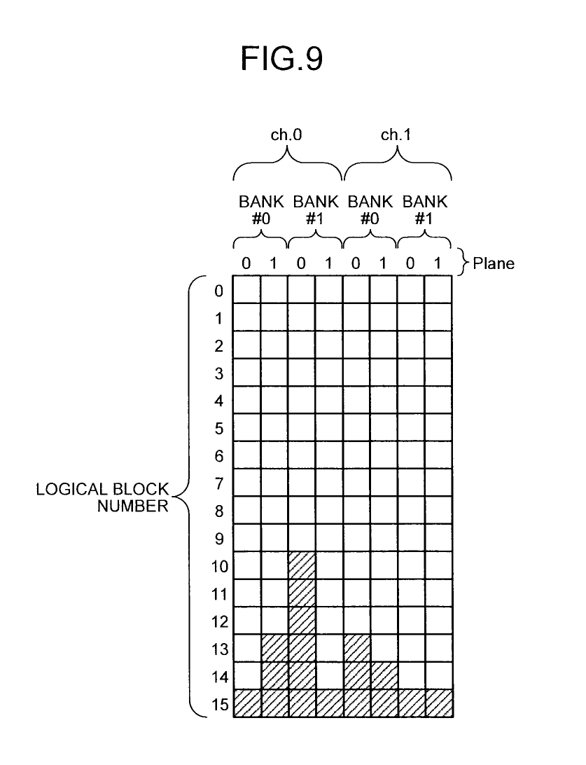

FIG. 9 is a diagram illustrating an array of the physical block numbers after execution of the process of S2. The physical block number is placed in each cell. The hatched cells indicate Bad Blocks. The rows are associated respectively with logical block numbers such that the logical block numbers are placed in ascending order from the start of the row. The arrangement of the physical block numbers is changed in each column such that the physical block numbers are arranged in the order of the group of Good Blocks and the group of Bad Blocks from the start of the row. In other words, the physical block numbers are placed such that the Bad Blocks are concentrated on a higher logical block number side. Consequently, the plurality of physical blocks is respectively allocated to any of the plurality of logical blocks such that the number of logical blocks including Bad Blocks in the NAND memory 20 is minimal and that the distribution of the numbers of Bad Blocks in the logical blocks is most biased.

Following the process of S2, the processing unit counts the number of Bad Blocks row by row (S3). In the example of FIG. 9, for example, the number of Bad Blocks arranged in a row corresponding to a logical block number “15” is “8”, and the number of Bad Blocks arranged in a row corresponding to a logical block number “14” is “4”.

Next, the processing unit sets, as use targets, all rows in which the number of Bad Blocks is less than the number of the parallel operation elements (S4). The number of the parallel operation elements indicates a maximum value of the number of the parallel operation elements that can operate in parallel. The number of the parallel operation elements can be obtained by, for example, multiplying the number of banks, the number of channels, and the number of the Districts 24 per memory chip 21. In other words, according to the example of FIG. 4, the number of the parallel operation elements is “8”. The processing unit does not set, as the use target, a row in which the number of Bad Blocks is equal to the number of the parallel operation elements. In the example of FIG. 9, the rows from a row corresponding to a logical block number “0” to the row corresponding to the logical block number “14” are the rows in which the number of Bad Blocks is less than “8”. The processing unit sets, as the use targets, from the row corresponding to the logical block number “0” to the row corresponding to the logical block number “14”.

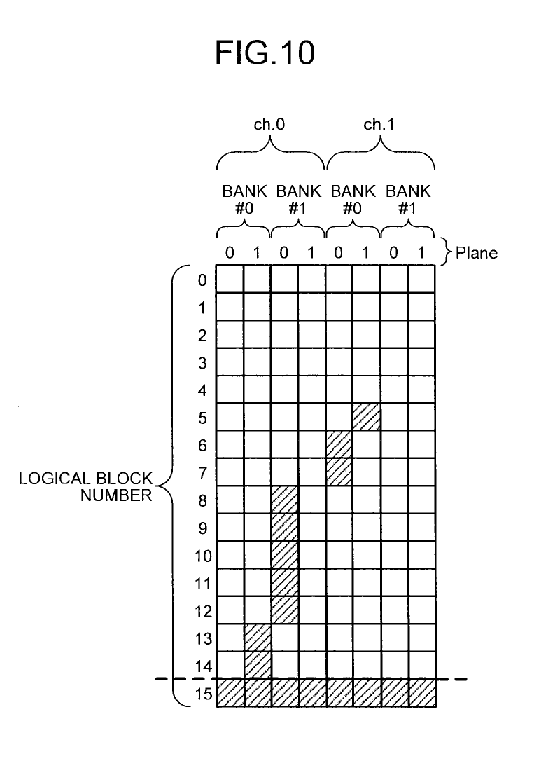

Next, the processing unit changes the arrangement of the physical block numbers belonging to the rows of the use targets in each column such that the numbers of Bad Blocks in the rows are equal among the rows of the use targets (S5). FIG. 10 is a diagram illustrating an array of the physical block numbers after the process of S5. For example, if the difference of the numbers of allocated Bad Blocks between any two rows of the use targets is “0” or “1”, it can be said that the numbers of Bad Blocks in the rows are equal among the rows of the use targets. In the example of FIG. 9, the total number of Bad Blocks included in the rows of the use targets is “10”, and the number of rows of the use targets is “15”. Hence, if the number of Bad Blocks belonging to the rows of the use targets is “0” or “1”, it can be said that the numbers of Bad Blocks in the rows are equal among the rows of the use targets. According to FIG. 10, the number of Bad Blocks in each row is “0” from the row corresponding to the logical block number “0” to the row corresponding to the logical block number “4”, and the number of Bad Blocks in each row is “1” from the row corresponding to the logical block number “5” to the row corresponding to the logical block number “14”. The row of the logical block number “15” being the row that is not the use target is configured of Bad Blocks. Hence, according to the array illustrated in FIG. 10, the numbers of Bad Blocks in the rows are equal among the rows of the use targets.

Next, the processing unit generates the second translation information 32 based on the array after the process of S5 (S6), and ends the operation related to the generation of the second translation information 32. In the process of S6, the processing unit records, in the second translation information 32, a logical block number associated with one row and physical block numbers indicating physical blocks included in the one row while associating the logical block number with the physical block numbers. The processing unit executes recording in the second translation information 32 for all the rows.

The processing unit uses a logical block corresponding to a row of the use target and does not use a logical block corresponding to a row that is not the use target. Moreover, the processing unit accesses, in parallel, Good Blocks constituting the logical block corresponding to the row of the use target.

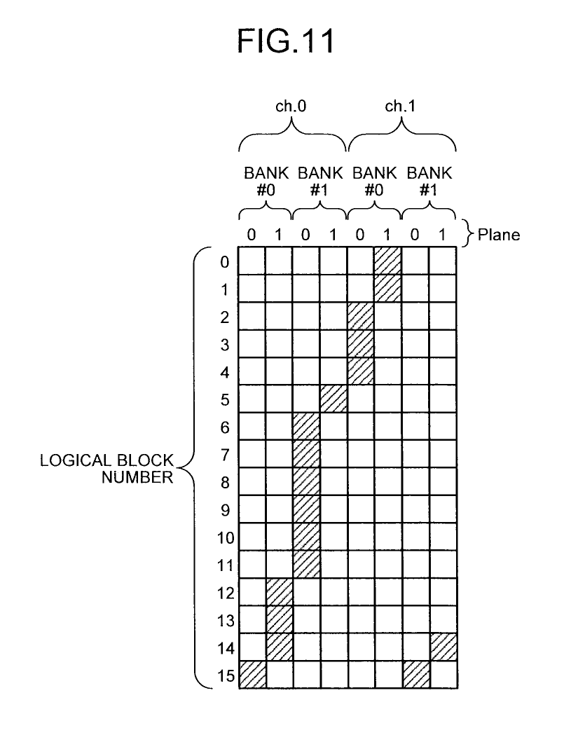

In the above description, it has been described that the processing unit sets, as the use targets, all rows in which the number of Bad Blocks is less than the maximum number of the parallel operations. However, all the rows may be set as the use targets regardless of the number of Bad Blocks. FIG. 11 is a diagram illustrating an array of the physical block numbers of when the processing unit has set all the rows as the use targets regardless of the number of Bad Blocks. The numbers of Bad Blocks in the rows are set to be equal among all the rows.

In this manner, according to the first embodiment, the processing unit allocates a group of physical blocks to each logical block such that the numbers of Bad Blocks in the logical blocks are equal. Consequently, the numbers of Good Blocks to be accessed in parallel are equal among the logical blocks. Accordingly, variations in access speed among the logical blocks can be reduced.

A case where a logical block including even one Bad Block is not used is considered. For example, for the array illustrated in FIG. 9, the processing unit sets the row of the logical block number “0” to the row of the logical block number “9” as the use targets, and discards the row of the logical block number “10” to the row of the logical block number “15”. In this case, Good Blocks included in the rows discarded are not used although they can be used. In contrast, in the first embodiment, a logical block including a Bad Block is also used. Accordingly, the storage capacity to be actually used can be increased as much as possible.

Moreover, the processing unit executes the first allocation process in which a plurality of physical blocks is allocated to any of a plurality of logical blocks such that the number of logical blocks including Bad Blocks is minimal and that the distribution of the numbers of Bad Blocks in the logical blocks is most biased; and the second allocation process in which the plurality of logical blocks is classified under the first logical block in which the number of Bad Blocks is the number of the parallel operation elements, and the second logical block in which the number of Bad Blocks is less than the number of the parallel operation elements and the Bad Blocks are allocated to the second logical blocks such that the numbers of Bad Blocks in the second logical blocks are equal. Consequently, the storage capacity to be actually used is maximized, and variations in access speed among the logical blocks can be reduced.

### Second Embodiment

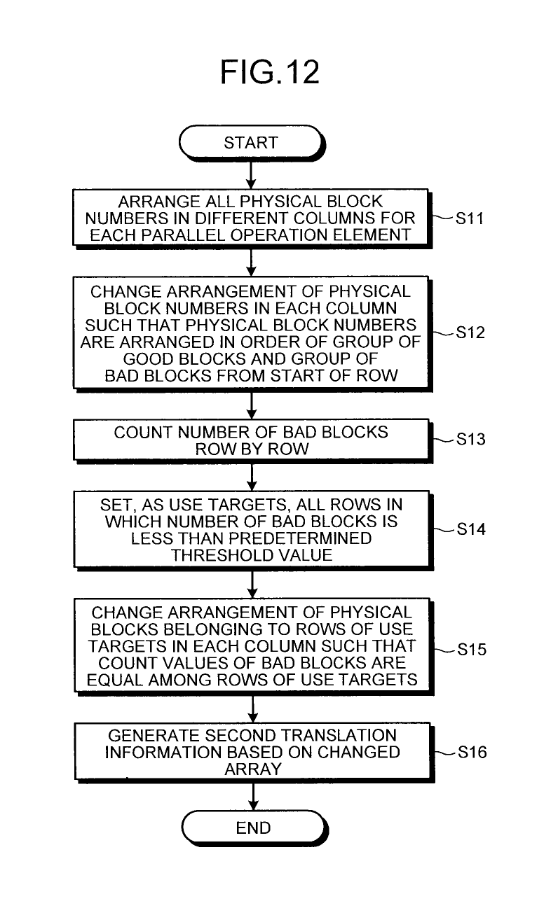

FIG. 12 is a flowchart illustrating the operations of a second embodiment to generate the second translation information 32. The processing unit executes similar processes to the processes from S1 to S3, in S11 to S13. The processing unit subsequently sets, as the use targets, all rows in which the number of Bad Blocks is less than a preset threshold value (S14). The threshold value used in the process of S14 is set from, for example, the outside. If “4” is used as the threshold value for, for example, the array illustrated in FIG. 9 to execute S14, the row corresponding to the logical block number “0” to the row corresponding to the logical block number “13” are set as the use targets.

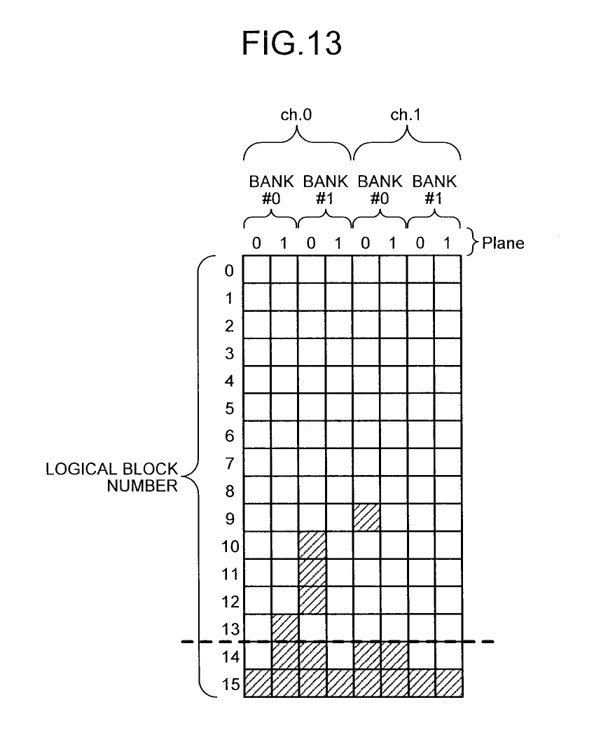

Next, the processing unit changes the arrangement of the physical block numbers belonging to the rows of the use targets in each column such that the numbers of Bad Blocks in the rows are equal among the rows of the use targets (S15). FIG. 13 is a diagram illustrating an array of the physical block numbers after the process of S15. As illustrated, the number of Bad Blocks in each row is “0” or “1” from the row corresponding to the logical block number “0” to the row corresponding to the logical block number “13”.

Next, the processing unit generates the second translation information 32 based on the array after the process of S15 (S16), and ends the operation related to the generation of the second translation information 32.

In this manner, according to the second embodiment, after the first allocation process, the processing unit classifies a logical block in which the number of Bad Blocks exceeds the predetermined threshold value under the first logical block, and a logical block in which the number of Bad Blocks does not exceed the threshold value under the second logical block. If the threshold value is set low, the number of Bad Blocks per logical block reduces. Accordingly, the number of Good Blocks per logical block of the use target increases. As a consequence, faster access becomes possible.

In the descriptions of the first and second embodiments, the processing unit operates as described above and accordingly Bad Blocks are allocated to logical blocks that are not the use targets on a priority basis, and the remaining physical blocks are respectively allocated to logical blocks of the use targets such that the numbers of Bad Blocks in the logical blocks are equal. Whether each logical block is or is not set as the use target may be set based on the number of Bad Blocks in each logical block, or logical blocks that are not the use targets may be preset.

Moreover, after the count of the number of Bad Blocks (that is, after the process of S3 or S13), the processing unit may set rows that are the use targets and rows that are not the use targets based on the comparison of the total number of Bad Blocks belonging to any of the rows that are not the use targets, and the preset allowable number of Bad Blocks out of all the physical blocks included in the NAND memory 20. For example, the processing unit sets rows that are the use targets and rows that are not the use targets such that the total number does not exceed the allowable number. The processing unit preferentially sets rows having more Bad Blocks as the rows that are not the use targets. For example, if the allowable number of Bad Blocks is “12”, and the array illustrated in FIG. 9 has been obtained at the time of the process of S3, the processing unit adds the numbers of Bad Blocks from a higher logical block number side. The total value of the number of Bad Blocks included in the row corresponding to the logical block number “15”, and the number of Bad Blocks included in the row corresponding to the logical block number “14” reaches “12” that is the allowable number. Accordingly, the processing unit sets, as the rows of the use targets, the row corresponding to the logical block number “0” to the row corresponding to the logical block number “13”.

Moreover, it has been described that the processing unit does not use a logical block corresponding to a row that is not the use target. If a Good Block is included in the row that is not the use target, the processing unit may access singly to the Good Block included in the row that is not the use target. Single access indicates access that is not parallel access.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile semiconductor memory including a plurality of parallel operation elements each having a plurality of physical blocks, each of the plurality of physical blocks being a unit of data erasing; and
a controller configured to
drive the plurality of parallel operation elements in parallel,
associate each of a plurality of logical blocks with a plurality of physical blocks each belonging to different parallel operation elements, and
level, among the plurality of logical blocks, the numbers of Bad blocks included in the plurality of physical blocks being associated with each of the plurality of logical blocks.

2. The memory system according to claim 1, further comprising a first management table, wherein the controller registers Good blocks into the first management table for each of the logical blocks.

3. The memory system according to claim 2, wherein the controller levels the numbers of Bad blocks in each logical block until the difference between the number of Good blocks associated with a first logical block registered in the first management table and the number of Good blocks associated with a second logical block registered in the first management table becomes one.

4. The memory system according to claim 2, further comprising a second management table including a corresponding relationship between a logical address specified by a host device and a third logical block registered in the first management table, wherein upon changing the association of the third logical block with a plurality of physical blocks, the controller does not update the second management table.

5. The memory system according to claim 2, wherein the controller associates Bad blocks with one or more fourth logical blocks preferentially and levels the numbers of Good blocks associated with a plurality of fifth logical blocks among the plurality of fifth logical blocks.

6. The memory system according to claim 5, wherein the controller levels the numbers of Bad blocks in each logical block until the difference between the number of Good blocks associated with a sixth logical block among the plurality of fifth logical blocks and the number of Good blocks associated with a seventh logical block among the plurality of fifth logical blocks becomes zero or one.

7. The memory system according to claim 5, wherein the controller does not use the one or more fourth logical blocks.

8. The memory system according to claim 6, wherein
the controller associates Bad blocks with the one or more fourth logical blocks preferentially until the number of the associated Bad blocks becomes a predetermined number or lower, and
the controller levels the numbers of Bad blocks in each logical block until the difference between the number of Good blocks associated with the sixth logical block and the number of Good blocks associated with the seventh logical block becomes zero or one.

9. The memory system according to claim 1, wherein the number of elements of the plurality of parallel operation elements is eight.

10. The memory system according to claim 1, wherein the nonvolatile semiconductor memory is a NAND flash memory.

11. A method for controlling a nonvolatile semiconductor memory including a plurality of parallel operation elements each having a plurality of physical block, each of the plurality of physical blocks being a unit of data erasing, the method comprising:
driving the plurality of parallel operation elements in parallel;
associating each of a plurality of logical blocks with a plurality of physical blocks belonging respectively to different parallel operation elements; and
leveling, among the plurality of logical blocks, the numbers of Bad blocks included in the plurality of physical blocks being associated with each of the plurality of logical blocks.

12. The method according to claim 11, further comprising registering Good blocks into a first management table for each of the logical blocks.

13. The method according to claim 12, further comprising performing the leveling until the difference between the number of Good blocks associated with a first logical block registered in the first management table and the number of Good blocks associated with a second logical block registered in the first management table becomes one.

14. The method according to claim 12, further comprising:
managing, with a second management table, a corresponding relationship between a logical address specified by a host device and a third logical block registered in the first management table;
upon changing the association of the third logical block with a plurality of physical blocks, not updating the second management table.

15. The method according to claim 12, further comprising:
associating Bad blocks with one or more fourth logical blocks preferentially; and
leveling the numbers of Good blocks associated with a plurality of fifth logical blocks among the plurality of fifth logical blocks.

16. The method according to claim 15, further comprising performing the leveling until the difference between the number of Good blocks associated with a sixth logical block among the plurality of fifth logical blocks and the number of Good blocks associated with a seventh logical block among the plurality of fifth logical blocks becomes zero or one.

17. The method according to claim 15, further comprising not using the one or more fourth logical blocks.

18. The method according to claim 16, further comprising:
associating Bad blocks with the one or more fourth logical blocks preferentially until the number of the associated Bad blocks becomes a predetermined number or lower, and
performing the leveling until the difference between the number of Good blocks associated with the sixth logical block and the number of Good blocks associated with the seventh logical block becomes zero or one.

19. The method according to claim 11, wherein the number of elements of the plurality of parallel operation elements is eight.

20. The method according to claim 11, wherein the nonvolatile semiconductor memory is a NAND flash memory.
